(19) United States
(12) Patent Application Publication
(10) Pub. No.: US 2015/0324909 A1
(43) Pub. Date: Nov. 12, 2015

(54) SYSTEM AND METHOD FOR CREATING AD HOC SELF-ENFORCING CONTRACTS IN NETWORK-BASED EXCHANGES

(71) Applicant: C1 Bank, St. Petersburg, FL (US)

(72) Inventors: Marcio deOliveira, Sarasota, FL (US); Trevor Burgess, St. Petersburg, FL (US); Vasyl Borysovych Martyniuk, St. Petersburg, FL (US)

(73) Assignee: C1 Bank, St. Petersburg, FL (US)

(21) Appl. No.: 14/270,913

(22) Filed: May 6, 2014

(51) Int. Cl. G06Q 40/02

(52) U.S. Cl. CPC G06Q 40/025

(57) ABSTRACT

Systems and methods enable the creation, administration, and enforcement of self-enforcing electronic contracts within a network-based participation exchange as well as the matching of participation opportunities with exchange participants having compatible profiles. In one embodiment, participation opportunity data is provided to an exchange participant computing device, and the exchange participant computing device transmits a participation opportunity purchase request to an exchange network computing device. In response to the purchase request, the exchange network computing device generates an electronic contract.

### TECHNICAL FIELD AND BACKGROUND

The present invention relates generally to the field of network-based market exchanges, and more particularly, to systems and methods for establishing and administering self-enforcing contracts within a participation exchange network.

Lending is an important part of business for many financial service providers. Financial service providers must meet the borrowing needs of customers by originating and servicing loans while also meeting regulatory requirements and maintaining adequate financial health as determined by metrics such as earnings, liquidity, capital assets, and the like. A loan participation exchange where financial service providers sell portions of a loan to exchange participants would permit financial service providers to meet customer borrowing needs without exceeding lending limits or violating regulatory requirements.

Traditional means for selling an interest in a loan or other investment places the burden on market participants to manually search lists of participation opportunities for suitable investments or lists of exchange participants for suitable investors. Loan participation contracts are negotiated and administered through telephone calls, meetings, email, or regular mail. Because loan participation contracts contemplate an ongoing business relationship over the life of a loan, the transaction cost for administering and enforcing the terms of a loan participation contract can be substantial. Moreover, the process of manually searching for suitable participation opportunities or exchange participants can be time consuming, and it can be difficult to successfully match participation opportunities with a compatible exchange participant. It would, therefore, be advantageous to provide a convenient and efficient means for matching exchange participants with compatible loan participation opportunities as well as an efficient means for creating, administering, and enforcing loan participation contracts.

Accordingly, it is an object of the present invention to provide systems and methods that permit convenient, efficient, and accurate pairing of exchange participants with loan participation opportunities. It is a further object of the present invention to provide systems and methods that allow for the creation, administration, and enforcement of self-enforcing, electronic contracts within a network-based exchange.

### SUMMARY

According to one embodiment of the invention, a method and system for creating a self-enforcing electronic contract in a network-based participation exchange is provided. The system includes: a computing device associated with an exchange network; a computing device associated with an exchange participant; a member database containing exchange participant profile data; and a participation database containing participation opportunity data. Participation opportunity data is provided to the exchange participant computing device. The exchange participant computing device transmits a participation opportunity purchase request to the exchange network computing device, and in response, the exchange network computing device generates an electronic contract.

In another aspect of the invention, the system performs a matching analysis prior to receiving the participation opportunity purchase request. The matching analysis evaluates one or more participation opportunities for compatibility with the exchange participant's profile data. The results of the matching analysis are provided to the exchange participant computing device. In yet another embodiment of the invention, the matching analysis evaluates two or more participation opportunities and ranks the participation opportunities according compatibility with the exchange participant's profile data.

Another aspect of the invention includes the additional step of determining compliance or noncompliance with one or more terms of the electronic contract and imposing conditions for noncompliance. A term of the electronic contract can include a periodic payment obligation and a condition for noncompliance can be a financial penalty.

A further aspect of the invention can include receiving by the exchange network computing device, an acknowledgement message transmitted by the exchange participant computing device that acknowledges receipt of participation opportunity data.

According to one embodiment of the invention, the participation opportunity is a financial interest in a loan. A first term of the electronic contract requires a borrower to make monthly payments, and a second contract term requires the exchange participant to acknowledge receipt of the participation opportunity data. The system determines compliance or noncompliance with the first and second contract terms and imposes a financial penalty for noncompliance with the first term. The system can also initiate period payments from a lead provider to the exchange participant.

### BRIEF DESCRIPTION OF THE DRAWINGS

Features, aspects, and advantages of the present invention are better understood when the following detailed description of the invention is read with reference to the accompanying figures, in which:

FIG. 1 is a schematic diagram of an exemplary hardware configuration for participation exchange network according to one embodiment of the invention;

FIG. 2 is a schematic diagram of the layers of a participation exchange system according to one embodiment of the invention;

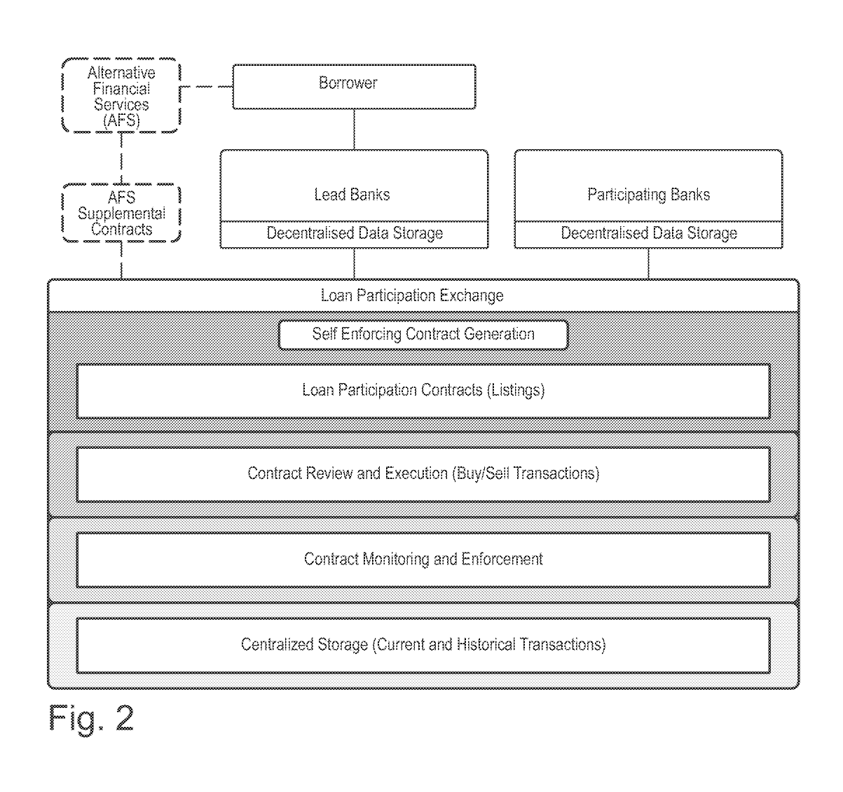

FIGS. 3A-B is a flow diagram illustrating creation, administration, and enforcement of a self-enforcing electronic contract according to one embodiment of the invention;

FIG. 4 is an exemplary input for a self-enforcing electronic contract according to one embodiment of the invention;

FIG. 5 is a flow diagram illustrating the function of a user-interface according to one embodiment of the invention;

FIG. 6 is an exemplary display screen for a network member login;

FIG. 7 is an exemplary display screen for creating a participation exchange account;

FIG. 8 is exemplary display screen for displaying terms of use for a participation exchange;

FIG. 9 is exemplary display screen for linking a financial account to a participation exchange account;

FIG. 10 is an exemplary display screen for selecting a linked financial account;

FIG. 11 is an exemplary display screen for creating a participation opportunity;

FIG. 12 is an exemplary display screen for creating a participation opportunity;

FIG. 13 is an exemplary display screen for displaying an inventory of participation opportunities;

FIG. 14 is an exemplary display screen for reviewing the details of a participation opportunity;

FIG. 15 is an exemplary display screen for reviewing the details of a participation opportunity;

FIG. 16 is an exemplary display screen for initiating a purchase request for a participation opportunity;

FIG. 17 is an exemplary display screen for displaying a network member's participation opportunities; and

FIG. 18 is a schematic diagram of a participation exchange network according to one embodiment of the invention.

### DETAILED DESCRIPTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete and will fully convey the scope of the invention and enable one of ordinary skill in the art to make, use, and practice the invention.

Disclosed herein are systems and methods that allow for the implementation of a participation exchange network capable of conveniently and accurately matching participation opportunities with compatible exchange participants. Although the systems and methods find particular application to the implementation of loan participation exchanges, those of ordinary skill in the art will appreciate that the systems and methods can be used to implement any type of network-based market exchange.

The systems and methods can be configured to perform a matching analysis that considers the characteristics of the loan participation opportunity (e.g., borrower information, loan information, etc.) and the exchange participant's preferences and profile data (e.g., financial health, growth targets, liquidity targets, risk profile, etc.). The systems also provide exchange participants with convenient access to relevant loan documents and regulatory compliance information prior to purchasing. In this manner, the systems provide an efficient platform that can reliably determine the nature and adequacy of a participation arrangement, ensure regulatory compliance, and provide network members with an opportunity to analyze the credit quality of a loan or loans underlying a loan participation opportunity. Through the use of self-enforcing electronic contracts, the systems and methods further provide a mechanism for quickly and conveniently executing, administering, and enforcing purchase transactions that satisfy common contractual conditions (e.g., payment terms, liens, confidentiality, enforcement) while minimizing the transaction costs, the occurrence of exceptions, and the need for intermediaries.

The lead financial service provider that originates the loan may create the participation opportunity and continue to service the loan after the sale of the participation opportunity. Thus, the sale of an interest in the loan on a participation exchange is transparent to customers so that consistency of customer service is maintained. The benefits to exchange participants include the opportunity for portfolio diversification and risk spreading as well as the ability to invest in large loans without incurring servicing burdens and origination costs. Exchange participants can include entities that provide alternative financial services and that operate outside of federally insured banks and thrifts. Thus, conventional financial service providers may interface with alternative financial service providers in a compliant manner.

As used herein, the term financial service provider (“FSP”) generally describes a person or entity providing lending and other financial services and includes banks, credit unions, thrifts, alternative financial service providers (“AFS”), or other types of financial institutions. The term FSP is used interchangeably with the terms provider, bank, or financial institution. The term lead provider denotes a provider offering a loan participation opportunity, and the term exchange participant denotes a purchaser of a loan opportunity. Both lead providers and exchange participants may also be referred to generally as network members. The term associate is used interchangeably with the term representative and generally describes an individual employed by or associated with a provider and who provides service to customers. The term user describes an individual who utilizes the systems and methods of the present invention.

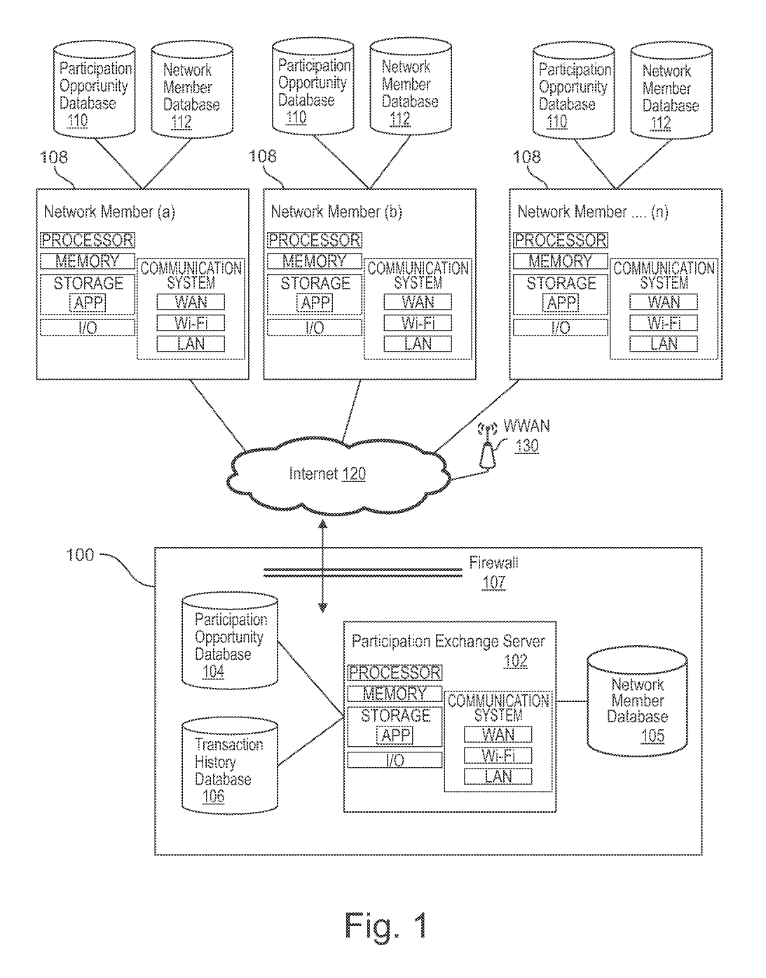

A hardware configuration for a participation exchange network according to one embodiment of the invention is shown in FIG. 1. The participation exchange network generally includes computing devices 108, participation opportunity databases 110, and network member databases 112 associated with one or more exchange network members and a computer system 100 associated with a participation exchange. The participation exchange computer system 100 may include a participation exchange server 102, a participation opportunity database 104, a network member database 105, a transaction history database 106, a firewall 107, and one or more computing devices operated by provider associates (not shown).

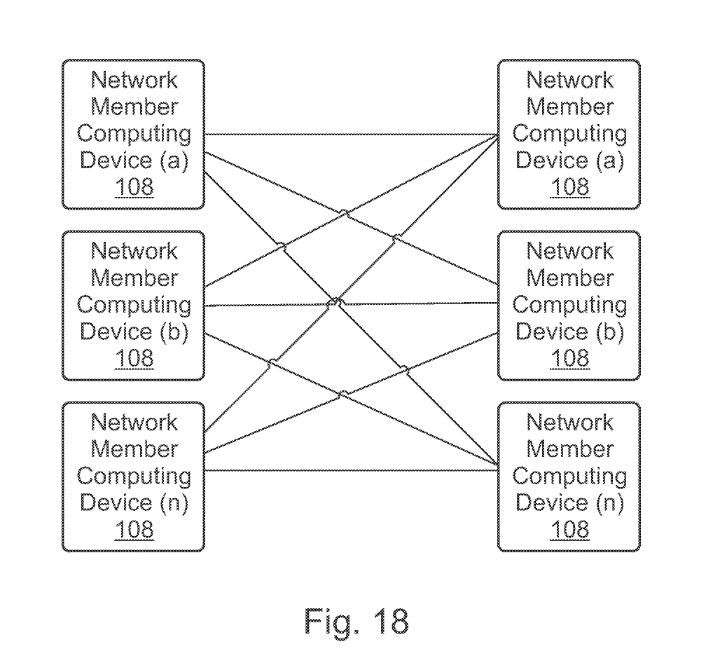

The participation exchange network shown in FIG. 1 is not intended to be limiting, and one of ordinary skill in the art will recognize that the systems and methods of the present invention may be implemented using other suitable hardware or software configurations. For example, the participation exchange computer system 100 may utilize only a single server implemented by one or more computing devices or a single computing device may implement one or more of the participation exchange server 102, participation opportunity database 104, network member database 105, transaction history database 106, firewall 107, and/or network member computing devices 108. Further, a single computing device may implement more than one step of the methods described herein; a single step may be implemented by more than one computing device; or any other logical division of steps may be used. In one embodiment, the participation exchange server 102 is associated with a network member that can be a lead provider or an exchange participant. With this embodiment, a single computing device can implement both the participation exchange server 102 and the network member computing device 108. In yet another embodiment illustrated in FIG. 18, the participation exchange network can be implemented as a distributed network with interconnected network member computing devices 108 where each network member can be either a lead provider or an exchange participant.

Any suitable computing device can be used to implement the network member computing devices 108 or the components of the participation exchange computer system 100. The network member computing devices 108, the participation exchange server 102, and the associate computing devices may include a processor that communicates with a number of peripheral subsystems via a bus subsystem. These peripheral subsystems may include a storage subsystem, user-interface input devices, user-interface output devices, a communication system, and a network interface subsystem. By processing instructions stored on one or more storage devices, the processor may perform the steps of the present method. Any type of storage device may be used, including an optical storage device, a magnetic storage device, or a solid-state storage device.

Typically, the network member computing devices 108 access the participation exchange computer system 100 or communicate with each other over the Internet 120 in the normal manner—e.g., through one or more remote connections, such as a Local Area Network (“LAN”) or Wireless Wide Area Network (“WWAN”) 130 based on 802.11 standards or a data connection provided through a cellular service provider. These remote connections are merely representative of a multitude of connections that can be made to the Internet 120 for accessing the participation exchange computer system 100 or communicating with other network member computing devices 108.

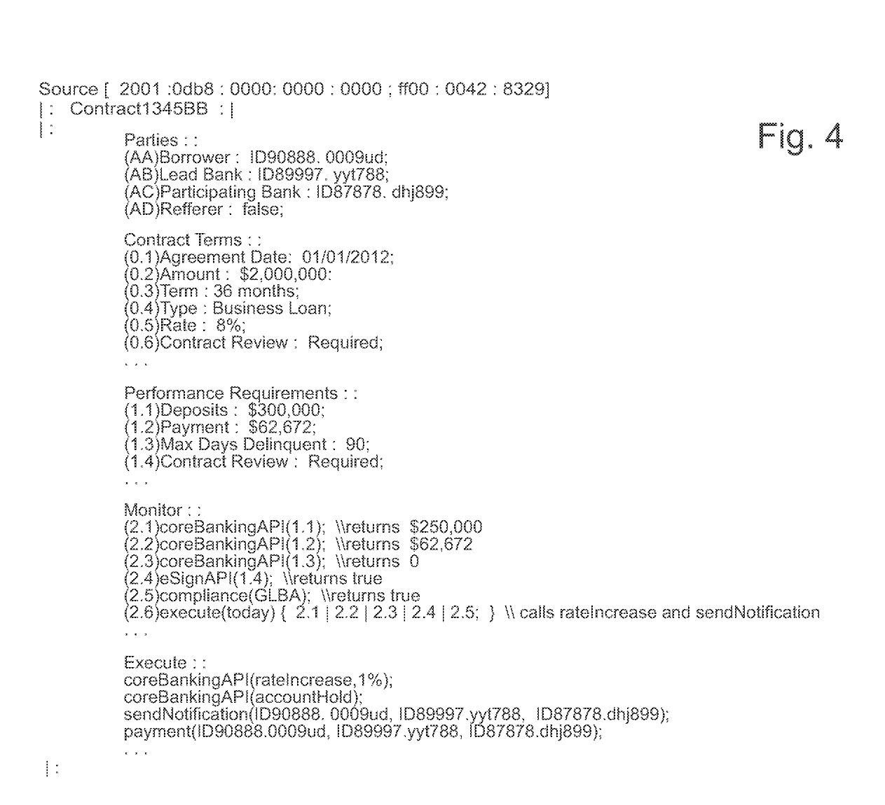

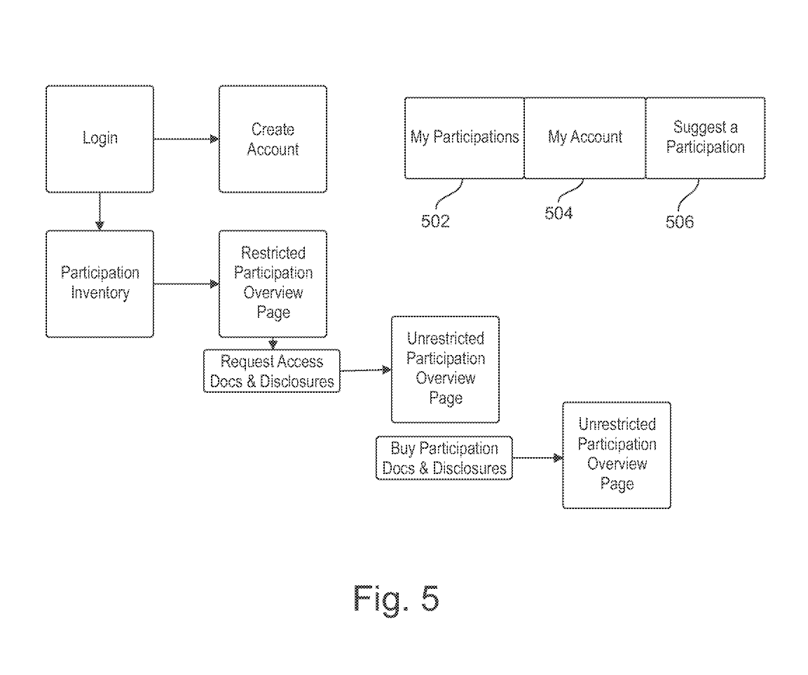

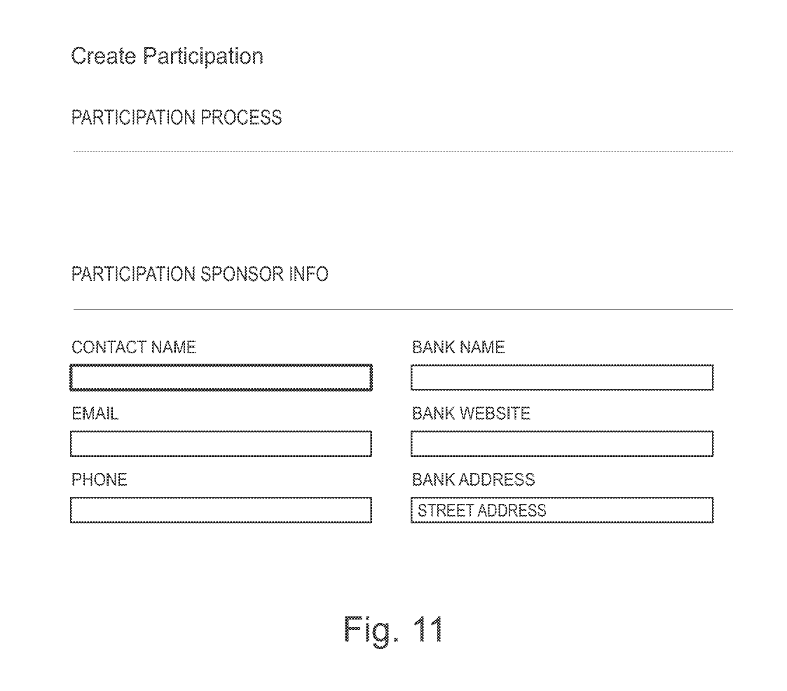

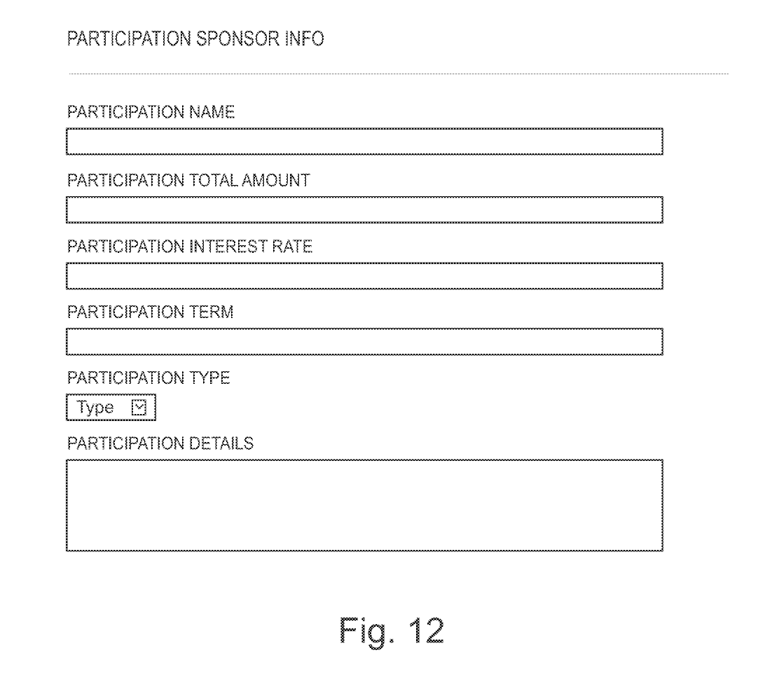

The participation exchange server 102 and network member computing devices 108 include one or more integrated software applications that provide a graphical user interface, permit communication with other electronic devices, and generally implement the steps of the methods disclosed herein. A flow diagram illustrating the operation of a user-interface according to one embodiment of the invention is shown in FIG. 5, and exemplary user interface display screens are depicted in FIGS. 6-17. One of ordinary skill in the art will appreciate that the exemplary functions and user-interface display screens disclosed herein are not intended to be limiting, and an integrated software application may include other display screens and functions.

Network members can securely access the participation exchange system by logging into the system using a unique username and password. An exemplary login screen is shown in FIG. 6 and includes text boxes 610 for entering authentication information and data fields 608 for displaying information to a network member user, such as an error message following an unsuccessful login attempt. The user-interface screens may include other features for accepting inputs from network member users, such as hyperlinks 618, pull down menus 614, check boxes 806, radio buttons 1004, and the like. A network member may have the option to automatically populate the username or password text boxes 610 by selecting a username from the dropdown menu 614. For network members that have forgotten a username or password, the system can transmit a reminder email or provide alternative means for authenticating identification through the Forgot Login? hyperlink 618. Once a username and password are entered, the network member can initiate a secure session by selecting the Login function 616.

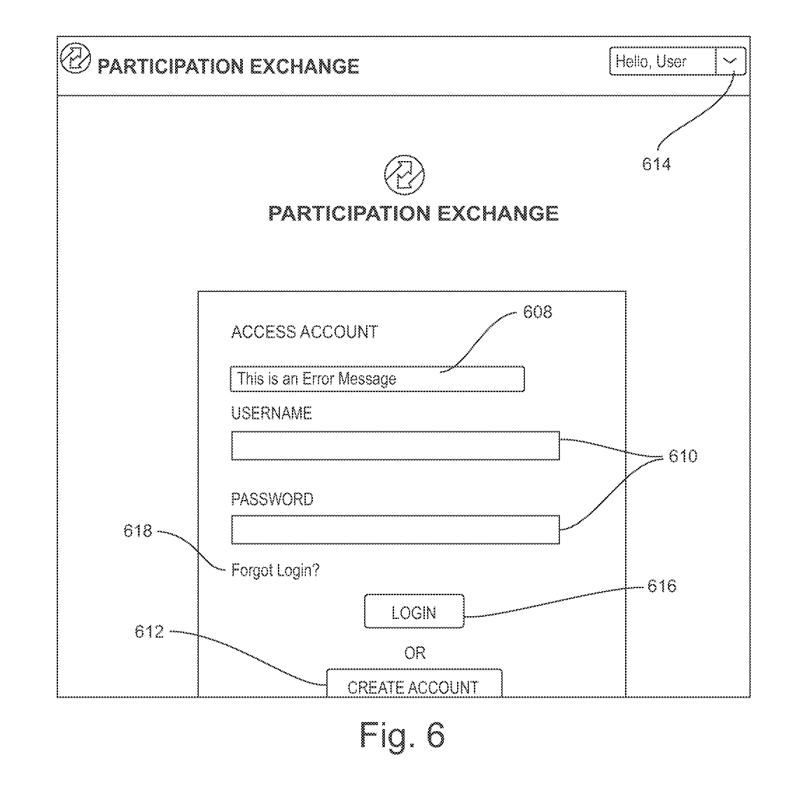

If a user does not have an account with the participation exchange network, then access to the exchange network is restricted, and the user may not able to view, purchase, or create participating opportunities. The user can create an account or become a network member by selecting the Create Account function 612. Selecting the Create Account function 612 takes the user to a registration screen like the exemplary screen shown in FIG. 7. The user creates an account by entering background information, such as the user's full name, organization, and contact information. The status 702 shown at the top of FIG. 7 indicates that certain functions are not available until the registration process is complete. Each network member can have one or more registered users with varying levels of access. So, for example, a network member can have multiple associates that are authorized to search and review participation opportunities but only a single associate that is authorized to purchase an interest in a participation opportunity.

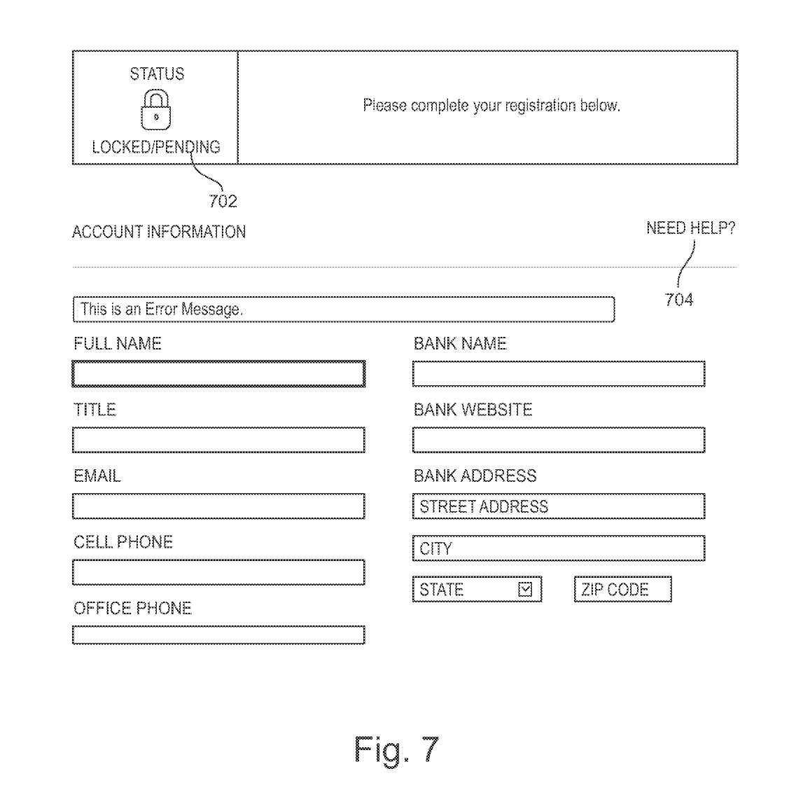

A user or network member registering with the participation exchange network can be required to agree to certain terms of use or disclosure. The terms of use and disclosure are presented to the user in a text box 802, as illustrated in FIG. 8. The user must select a check box 806 consenting to the terms before selecting the Submit Form 808 function to continue. Users can also be given an opportunity to print the terms of use and disclosure by selecting a Print Terms function 804.

The user interface display screens can optionally incorporate a help function available, for example, through the Need Help? hyperlink 704 in FIG. 7. The help function 704 assists the user by directing the user to a display screen containing explanations of the different text boxes and data fields or explanations about other operations and functions of the system. Other methods of assisting a user may be provided through the help function 704, such as permitting users to download a document containing useful information.

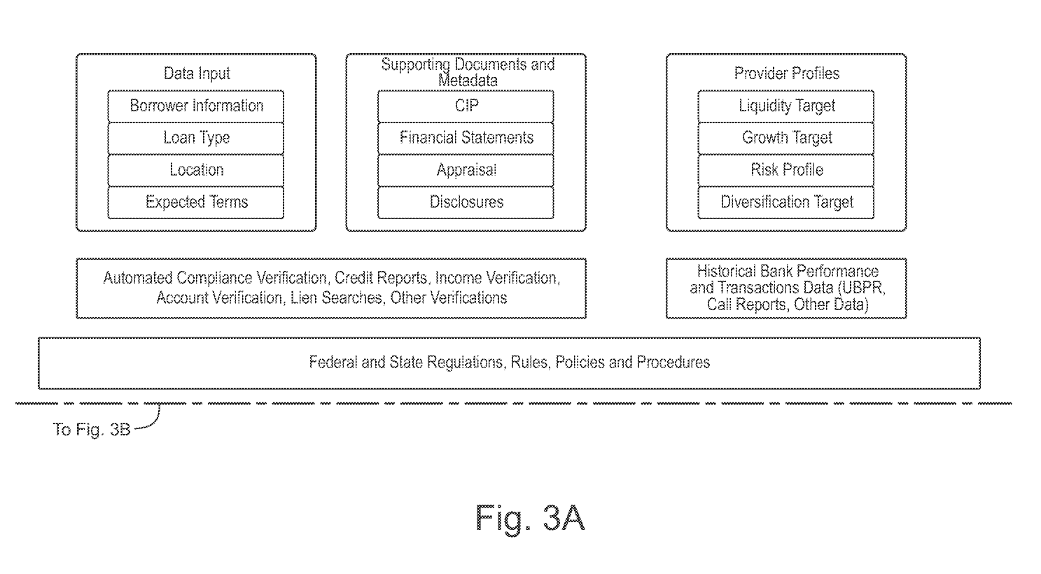

A financial service provider that is registering as a network member for the first time can be required to provide detailed profile data, which includes financial information, supporting documentation, or other relevant documents and information. Financial information may include performance and composition data used as an aid in evaluating the adequacy of a financial service provider's earnings, liquidity, capital, and asset and liability management. As illustrated in FIG. 3, financial service provider profile data includes a variety of information that can be utilized to match exchange participants with compatible participation opportunities, including, for example, a financial service provider's liquidity target, growth target, risk profile, or investment diversification targets. In particular, profile data can include, for example, whether the financial service will act as a lead provider or an exchange participant or whether provider is interested in purchasing participation opportunities with specific characteristics, such as participation opportunities involving commercial or residential loans, participation opportunities of certain dollar amount, or opportunities involving loans from a particular geographic location.

The financial service provider's risk profile provides rules, models, parameters, and other inputs to the matching analysis to ensure that exchange participants are matched with participation opportunities that are compatible with the exchange participants' desired investment risk level. Required documentation may include documents that can be utilized to verify a financial service provider's regulatory compliance and financial status. For instance, a service provider can be required to provide its state charter, audit and credit reports, or documents concerning the provider's privacy policy in compliance with the Gramm-Leach-Bliley Act (“GLBA”).

In addition to input from financial service providers, the system can also gather profile data from a variety of other sources, including public records and filings, like a financial service provider's Uniform Bank Performance Report (“UBPR”) and Consolidated Report of Condition and Income (“call report”) available through the United States Federal Financial Institutions of Examination Council (“FFIEC”). The system can utilize data from the call report as well as other sources as profile data for the financial service provider. The profile data is in turn utilized to match exchange participants with compatible participation opportunities. To illustrate, a call report might indicate that a financial service provider would exceed its capital requirements with an investment that exceeds $10 million. The system could, therefore, determine that a participation opportunity requiring a minimum investment of $20 million would not be compatible with the exchange participant's profile data, and exchange participant might not be permitted to purchase an interest in such a participation opportunity, or the opportunity would not be recommended to the exchange participant.

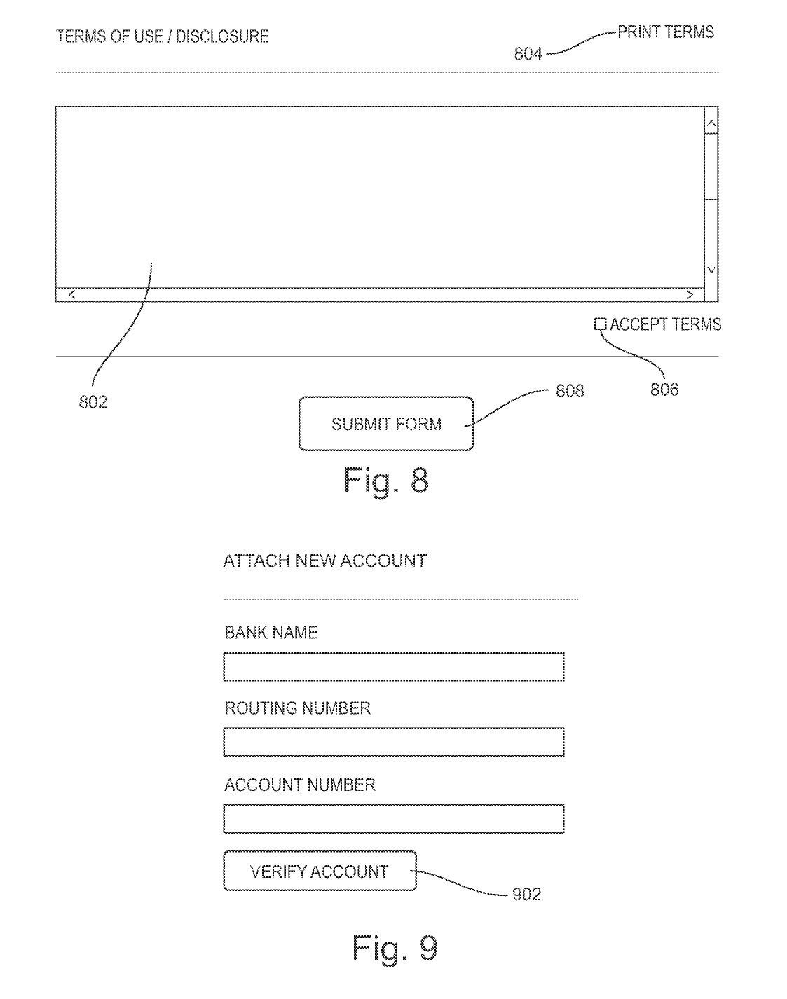

Once registered, network members have the ability to link one or more financial accounts to the network member's participation exchange account. An exemplary display screen for linking a financial account is shown in FIG. 9. Linking a financial account facilitates the purchase and administration of participation opportunities by providing a funding source or deposit account for automated or substantially real time payments and purchasing. The financial accounts can optionally be verified using account ownership verification techniques, and verification can be initiated by, for instance, selecting the Verify Account 902 function in FIG. 9.

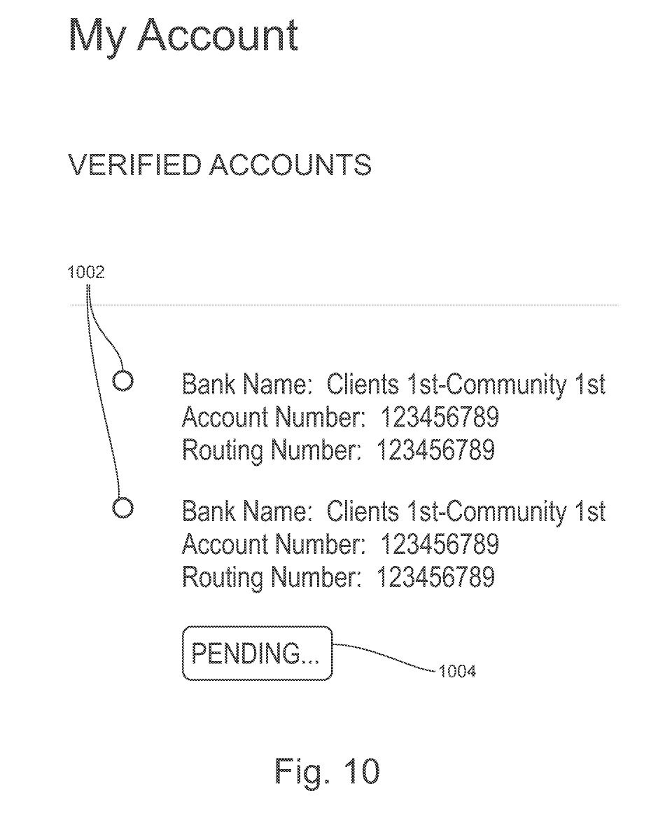

In one embodiment, a linked financial account is verified by sending a micropayment of a random amount to the account and asking the network member to verify the amount of the deposit. In this manner, it can be determined in substantially real time whether the account exists, whether the account is in good standing, and whether the network member has rights to the account. Once a financial account is verified and linked to a network member's participation exchange account, the network member can utilize the financial account to make payments or deposits through, for example, the display screen shown in FIG. 10 where the network member selects a radio button 1002 that corresponds to the financial account that should be utilized to complete a particular transaction. After selecting an account, a transaction status 1004 is displayed to indicate whether the transaction is pending, failed, canceled, or successfully initiated.

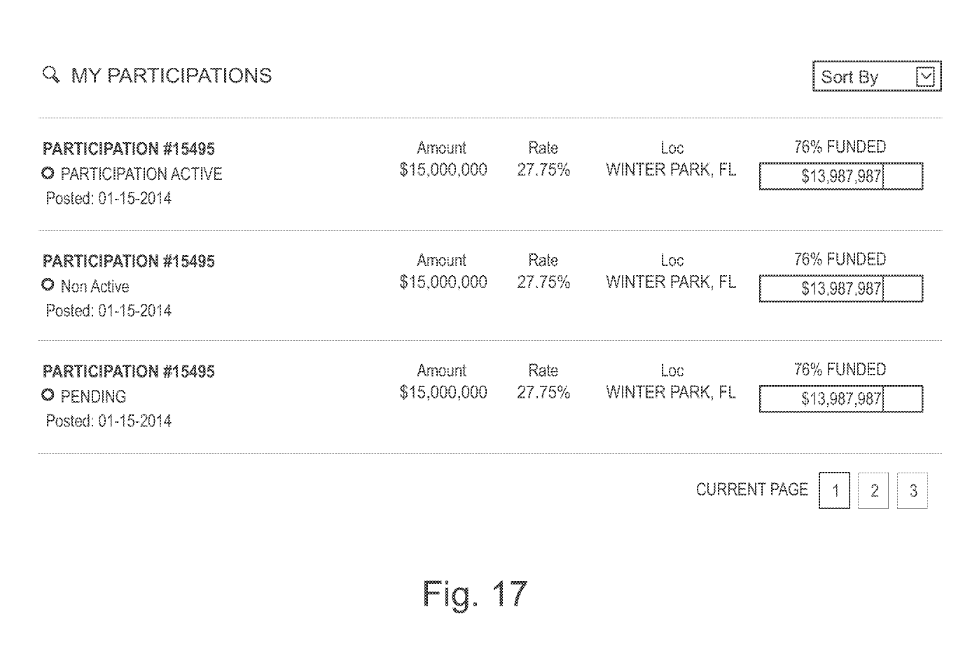

Once a network member is registered, the network member has access to certain account management functions, such as the My Participations 502, My Account 504, and Suggest a Participation 506 functions depicted in FIG. 5. The My Participations function 502 optionally displays a list of participation opportunities created by a lead provider or purchased by an exchange participant as well as information about the participation opportunities, including the participation identifier, status, amount, interest rate, geographic location, funded amount, or any other relevant information. An exemplary My Participations list is shown in FIG. 17. The My Account 504 feature permits a network member to review and edit details of a participation exchange account. The Suggest a Participation feature 506 initiates a search for participation opportunities that match an exchange participant's profile data, as discussed in more detail below. Those of ordinary skill in the art will appreciate that these exemplary account management functions are not intended to be limiting, and a variety of other account management functions can be provided.

Network members become a lead provider by creating a loan participation opportunity and making it available to exchange participants. A lead provider can be the originator of a loan, the servicer, or both. The lead provider can originate or service loans alone on in combination with other financial service providers, including entities offering alternative financial services. Alternatively, the lead provider might have acquired the loan from the originator or other third party. Preferably, the loan is associated with documents and information that permit financial service providers, including lead providers and exchange participants, to evaluate the credit quality and risk of the loan. Such documentation and information is typically generated during the origination process.

Loan origination generally refers to the process by which a financial service provider processes a loan application and disburses the funds. Loan origination can be analogized to a specialized form of account opening. Like account opening, loan origination involves authenticating the borrower's identification, evaluating the risk of a loan (i.e., underwriting), and ensuring regulatory compliance. The origination process includes performing one or a combination of identity authentication and risk-assessment analyses, such as: account ownership verification; identity verification (“IDV”); employment and income verification; capacity analysis; credit analysis; collateral analysis; United States Office of Foreign Asset Control (“OFAC”) screening; politically exposed person (“PEP”) screening; historical account analysis; and any other relevant identity authentication and risk-assessment techniques.

Loan origination utilizes information received from a multitude of sources, including information received directly from a borrower, information obtained from third-party agencies (e.g., credit bureaus and insurers), and information obtained from public records. Typical sources of public records include, but are not limited to: court files; state and federal tax records; property records; U.S. Social Security Administration Verification Services; the Death Master File published by the U.S. Department of Commerce; and secretary of state filings from all fifty states. IDV techniques compare information obtained from third-party agencies and public records against information received from the borrower. Inconsistencies in the data sets represent possible indicia of fraud or mistaken identity, which is relevant to assessing the risk level of the loan.

Borrower employment can be verified by contacting current and former employers to request verification or by comparing the employment history provided by a borrower against the borrower's tax records. Tax records are also used to verify a borrower's reported income. A borrower's income can also be compared to publicly available databases of salaries for different jobs and professions.

A capacity analysis evaluates a borrower's ability to make payments on a loan by examining the borrower's employment, income, current debts, and assets. A capacity analysis considers not only the amount of income but also whether the income is derived from self-employment, commissions, or other sources that are considered riskier than a regular salary. A capacity analysis also considers a borrower's debt-to-income (“DTI”) ratio. DTI is calculated by totaling a borrower's monthly liabilities and obligations and dividing by the borrower's monthly income. A higher DTI can be an indication that a borrower poses a higher risk. Assets also factor into evaluating the borrower's capacity, and borrowers with higher amounts of liquid assets are typically considered a lower risk.

A credit analysis evaluates, among other things, how well a borrower manages current and prior debts, and the analysis generally relies on credit reports obtained from third-party credit bureaus. A credit report can contain information about the borrower's credit score, current and prior credit cards, loans, collections, repossession, foreclosures, and information from other public records (e.g., tax liens, judgments and bankruptcies).

The collateral analysis evaluates the nature and value of the property underlying the loan. The value of the property is determined through an appraisal and is used to determine a loan to value (“LTV”) ratio, which is the ratio of the loan amount to the value of the property. A higher LTV generally correlates to a higher risk. The nature of the collateral also bears on the risk of a loan. For instance, loans that are used to purchase a single family home or townhome are considered lower risk than loans used to purchase a high-rise condominium. And loans used to purchase owner-occupied homes or second homes are considered lower risk than loans that are used to purchase investment property.

OFAC and PEP screening checks borrower information against public or private databases of individuals known to present an increased risk to the provider or who are precluded by law from engaging in certain financial transactions. In the case of OFAC screening, the borrower information is compared against a specially designated national list (“SDN list”) maintained by the U.S. OFAC of groups and individuals who are deemed to present a threat to national security and foreign or economic policy, such as terrorists, money launders, organized crime affiliates, and narcotics traffickers. Politically exposed persons are individuals entrusted with a prominent public function and who are presumed to be at a higher risk for involvement in bribery and corruption as a result of their position and influence.

Historical account analysis considers both positive and negative account information predictive of borrower risk. For instance, a large average deposit account balance is a positive indicator that the borrower does not pose a high risk while multiple instances of overdraft or not sufficient funds (“NSF”) withdraws indicates a higher risk. Risk factors considered as part of a historical analysis may be incorporated into a model that uses a set of logical rules to evaluate customer risk or considered as part of a quantitative risk assessment procedure. Those skilled in the art will appreciate that numerous factors bear on the risk level posed by a borrower or loan, and the exemplary factors discussed herein are not intended to be limiting.

Exemplary display screens for creating a participation opportunity are shown in FIGS. 11-12, and FIGS. 3-4 illustrate possible data inputs for creating a participation opportunity. Creating a participation opportunity requires that a lead provider enter background information about the provider as well as data and information about the loan participation opportunity, such as: (1) a participation opportunity identifier or name; (2) the total value of the loan and the amount available for participation; (3) the interest rate; (4) the term of the loan in months; (5) the nature of the loan (e.g., residential or commercial); (6) the type of loan (e.g., prime, Alt-A, or subprime); (7) the geographic location of the borrower; (8) the industry of the borrower for commercial borrowers; (9) information concerning the nature of the collateral property; and (10) any other relevant information.

As illustrated in FIG. 3, a lead provider creating a participation opportunity can also be required to submit documentation relating to the loan. Examples of loan documents include, but are not limited to: (1) the mortgage note from the borrower; (2) borrow disclosures relating to income or employment (e.g., W-2s, tax schedules, a letter from a borrower's employer, etc.); (3) borrower financial statements; (4) credit reports; (5) title searches; (6) property appraisals; and (7) property inspection reports. Loan documentation can also include a variety of other information relating to the loan originator's customer identification program (“CIP”) that is used to authenticate the borrower's identification, underwrite the loan, and ensure compliance with regulatory requirements.

Data and information relating to network member accounts and participation opportunities can be stored respectively to a network member database 105 and a participation opportunity database 104 on the participation exchange computer system 100. Alternatively, the system can be implemented as a distributed system with decentralized storage where information pertaining to network member accounts and participation opportunities is stored to network member databases 110 and participation opportunity databases 112 associated with the network member computing device 108.

Exchange participants can search the loan participation opportunity databases 104 & 112 for participation opportunities that match the exchange participant's profile data, and conversely, lead providers can search for exchange participants with profile data that is compatible with a given participation opportunity. An exchange participant can initiate an automated search by, for example, utilizing the Suggest a Participation 506 function.

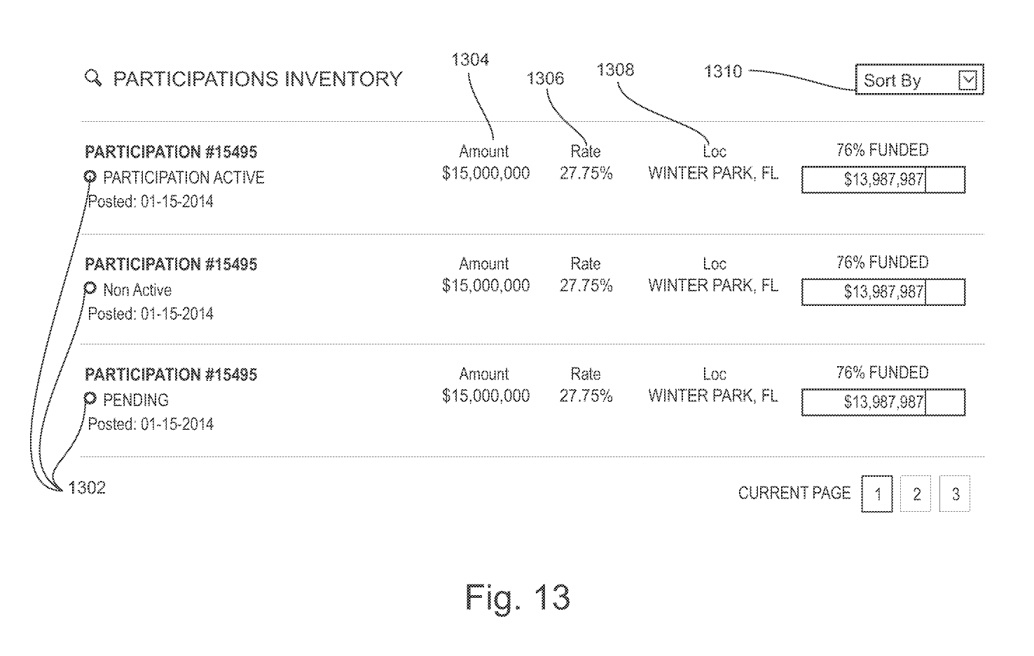

Participation opportunities can be searched using any suitable searching technique, including keyword searches, categorical searches, or a manual review of list entries. To illustrate, an exchange participant can perform a categorical search for all participation opportunities that involve commercial loans made in Florida for an amount of at least $15 million. The system then displays the search results in a participation list, like the list shown in FIG. 13. Using a pull-down menu or other sorting function 1310, the list can be further organized according to certain criteria, such as participation opportunity status 1302 (e.g., Active, Non Active, Pending), amount 1304, interest rate 1306, or geographic location 1308.

A search can also be conducted by performing a matching analysis that evaluates the likelihood that each participation opportunity is compatible with an exchange participant's profile data. The participation opportunities are ranked and displayed to the user according to the likelihood that a participation opportunity is a match with the most likely matches being displayed first. A matching analysis can also be performed following a keyword, categorical, or other search to further refine the search results and rank the results according to relevance.

The matching analysis can be implemented as a set of logical rules or as a quantitative model. The implementation of a matching analysis can be better understood with reference to the following simplified example. An exchange participant's profile data might indicate that: (1) a participation opportunity purchase of over $10 million would exceed the exchange participant's liquidity target; (2) the exchange participant's growth target seeks interest rates of over five percent; (3) the exchange participant has a risk profile that permits only low or moderate risk investments; and (4) the exchange participant's diversification target recommends acquiring commercial loans in the Pacific Northwest region of the United States.

The exchange participant, seeking participation opportunities that match its growth target, may run a category search for all participation opportunities with interest rates over five percent. Before displaying the search results to the exchange participant, the system can further refine the search results and rank the results according to the likelihood that the participation opportunity is an appropriate match for the exchange participant's profile data. Examples of logical rules implementing a matching model include rules that: (1) display participation opportunities of over $10 million last in the search results list where it is assumed that an exchange participant is unlikely to choose an opportunity that causes the participant to exceed its liquidity target; (2) rank loans with fewer risk factors higher than loans with more risk factors; and (3) rank loans in the northwestern United States higher loans from other regions.

In this example, because the exchange participant's risk profile targets low or moderate risk participation opportunities, opportunities with one risk factor—such as a loan made to purchase an investment property—will be ranked higher (i.e., a more likely match) than participation opportunities with two or more risk factors—such as a subprime loan used to purchase an investment property. On the other hand, a participation opportunity of over $10 million that exhibits one risk factor might be ranked lower than a participation opportunity with multiple risk factors but of an amount less than $10 million.

An exchange participant's risk profile can optionally provide rules, models, parameters, and other inputs to the matching analysis. One example would be rules that preclude consideration of participation opportunities involving: (1) subprime loans; (2) loans with a LTV over one; or (3) loans that exhibit three or more predetermined risk factors. The exchange participant's risk profile can also include a quantitative component. One example would be a risk model that assigns predetermined numeric scores to certain risk factors and precludes consideration of participation opportunities with an overall score over a given amount.

A quantitative matching analysis model can also be implemented by assigning numeric scores to different participation opportunity matching criteria. For instance, considering the exemplary exchange participant profile data given above: (1) participation opportunities of an amount over $10 million can be assigned a numeric score of “1” to indicate a low relevance or likelihood of matching while opportunities of less than $10 million are assigned a score of “3;” (2) participation opportunities can be assigned a score of “3” if they have two or fewer risk factors but a score of “1” if they have more than two; and (3) participation opportunities can be assigned a score of “5” if they involve commercial loans in the Pacific Northwest but a score of “1” if they involve loans from any other geographic region. The numeric scores for each participation opportunity are summed to yield an overall score, and opportunities with the largest overall scores are displayed higher on the search results list. So, for example, a participation opportunity of $15 million involving no risk factors and a residential loan in the Pacific Northwest would be ranked higher (total score of “9”) than a participation opportunity of $5 million involving no risk factors and a loan from another region of the country (score of “7”).

The numeric scores in the quantitative matching model can be adjusted to reflect the relative weight or importance of each factor in the matching analysis. Additionally, historical transaction data can be used to adjust the models and scores. For instance, a participation exchange network may determine based on historical data that exchange participants routinely purchase participation opportunities with fewer risk factors even if the participation opportunity falls outside of the exchange participant's geographic diversification target. In the example above, the numeric score assigned to participation opportunities with two or few risk factors can be adjusted to “5” while the numeric score assigned to a geographic preference match can be changed to “3” to reflect that this factor is less relevant to matching.

Other matching algorithms can also be used. One example is to rank participation opportunities according to the percentage of an exchange participant's profile requirements are that are satisfied by a participation opportunity. For instance, a participation opportunity that meets three of an exchange participants four profile preferences can be scored as a 75% match. While the matching analysis has been described generally with reference to the examples above, those of ordinary skill in the art will appreciate that the examples are not intended to be limiting and that any suitable matching analysis algorithm can be used, and the analysis can consider a wide range of potential factors.

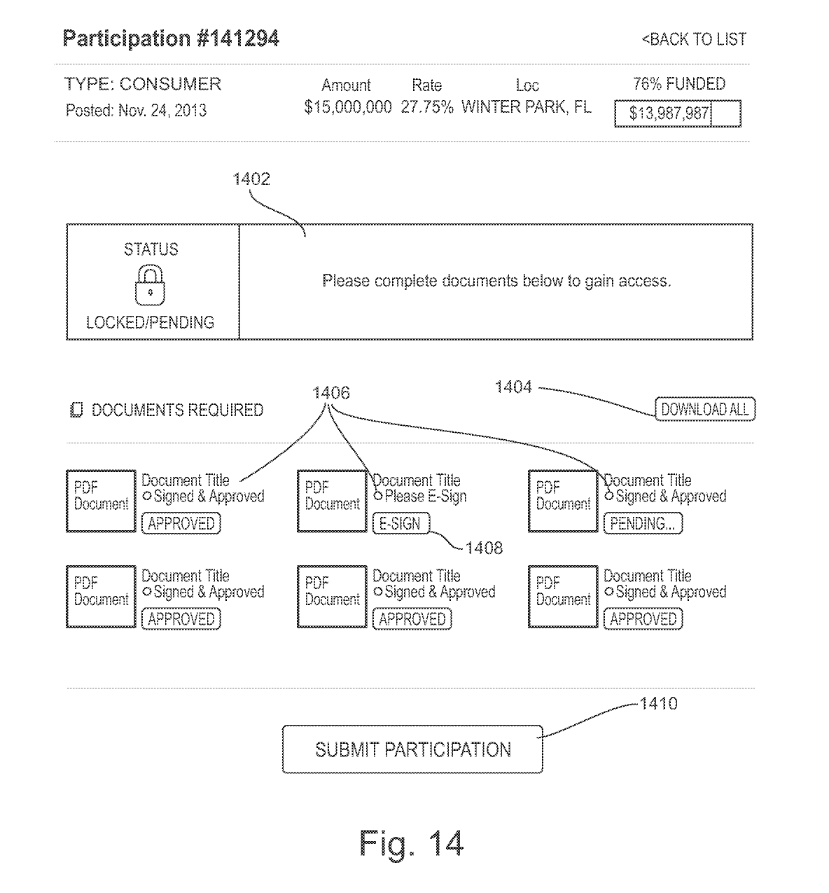

Upon selecting a participation opportunity for purchase, an exchange participant can be taken to the restricted participation opportunity display screen of FIG. 14. A notice 1402 is displayed to the exchange participant indicating that certain tasks must be completed before the full details of the participation opportunity can be displayed or before the participation opportunity becomes available for purchase. In the embodiment depicted in the attached figures, the exchange participant is required to review or indicate agreement with certain documents and terms before purchasing the participation opportunity. By way of example, the exchange participant might be required to: (1) acknowledge receipt and review of certain loan documents, like the mortgage note or borrower disclosures; (2) indicate agreement with certain contractual terms of the participation opportunity, such as representations and warranties, an arbitration clause, or a confidentiality provision; or (3) acknowledge receipt and review of certain documents necessary to ensure regulatory compliance.

An exchange participant can download the documents to review by selecting the Download All function 1404. When a task is complete, the exchange participant can acknowledge review of a document or agreement certain the terms by selecting the E-Sign function 1408 to electronically sign the document and transmit an acknowledgement message to the lead provider computing device 108 or the participation exchange server 102. The status of an exchange participant's compliance with a particular task is indicated with a status message 1406. When all required tasks are complete, the exchange participant can proceed with a participation opportunity purchase by selecting the Submit Participation function 1410.

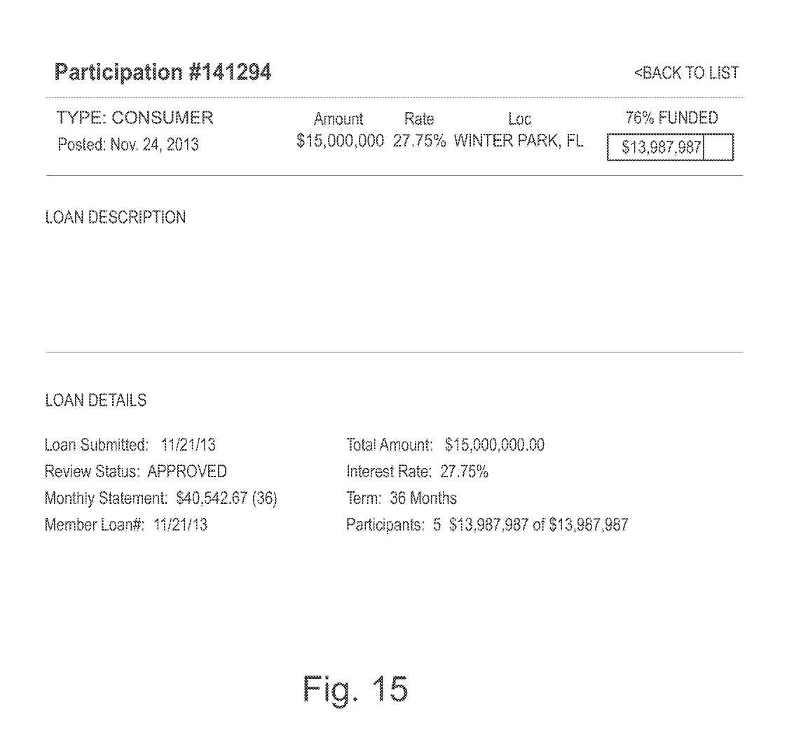

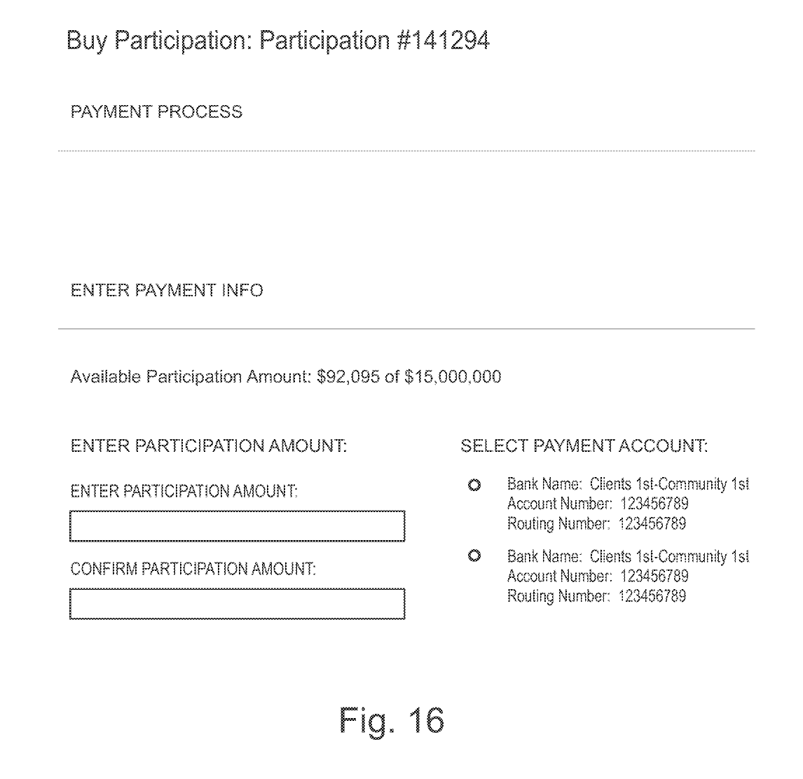

If the tasks are successfully completed, the exchange participant is able to access a display screen shown in FIG. 15 that shows additional details of the participation opportunity, such as the date of the loan, the term of the loan in months, the monthly payment amounts, the number of other exchange participants that have purchased an interest, as well as other loan description details. As illustrated in FIG. 16, an exchange participant can continue with the participation opportunity purchase by entering details regarding the amount of the purchase, the source of the payment funds, as well as other relevant information.

In short, the system provides a mechanism for matching participation opportunities with compatible exchange participants and allows exchange participants to access relevant documents prior to purchasing. In this manner, the system provides an efficient platform that can routinely determine the nature and adequacy of a participation arrangement and that can provide network members the opportunity to analyze the credit quality of a loan or loans underlying a participation opportunity. The system also enforces borrower privacy, security, and other regulatory requirements by, for instance, requiring lead providers make the lead provider's privacy policy available prior creating a participation opportunity or by requiring exchange participants to review and agree to such policies prior to purchasing.

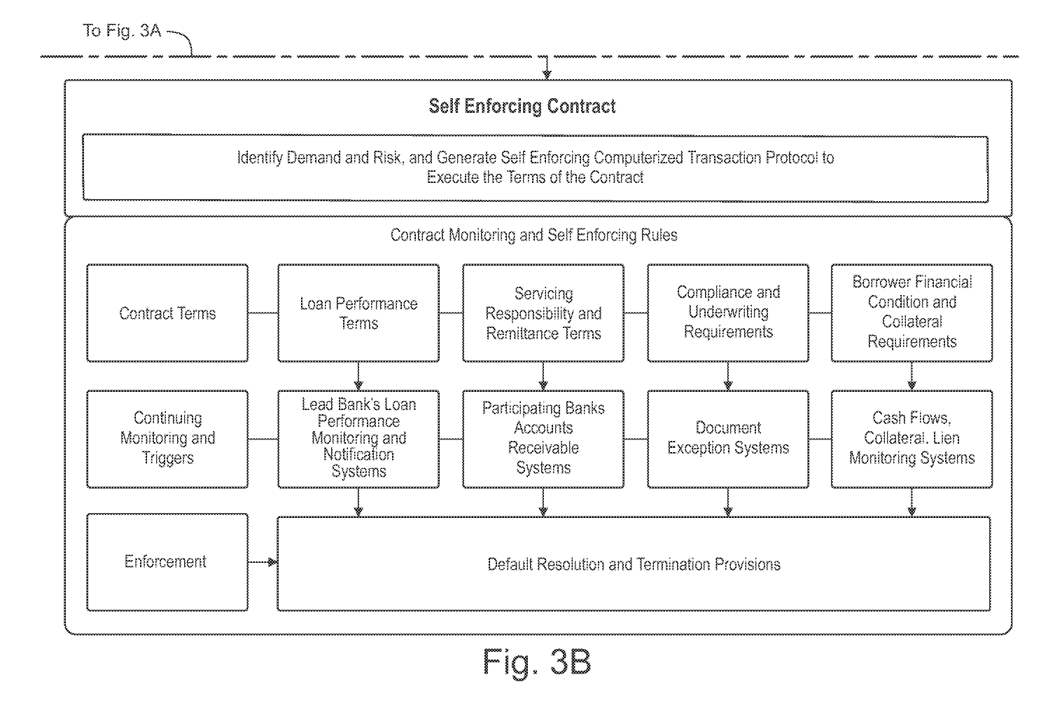

Creation and administration of a self-enforcing electronic contract according to one embodiment of the invention is illustrated in FIG. 4. A lead provider or exchange participant can specify a multitude of contract creation, administration, and enforcement terms and parameters. These terms and parameters can be entered into a graphical user-interface, written as a text-based software script, or specified using any other suitable technique known to one of ordinary skill in the art.

In one embodiment, creation, administration, and enforcement of an electronic contract are performed by one or more software applications integrated with the network member computing devices 108. The terms and parameters can be at least partially specified by a lead provider prior to creating or selling an interest in a participation opportunity. This allows a lead provider to efficiently monitor and enforce the borrower's compliance with the terms of a loan before selling an interest in the loan to an exchange participant. Terms and parameters of the participation opportunity can be modified or expanded after the participation opportunity is created and sold.

Self-enforcing electronic contract creation, administration, and enforcement can be better understood with reference to the exemplary embodiment shown in FIG. 4, which illustrates a text-based software script that executes instructions to accomplish the creation, administration, and enforcement of a participation opportunity contract. Information relating to the identities of the parties and the terms of the loan are specified under the headings “Parties” and “Contract Terms.” Parameters (AA), (AB), and (AC) specify unique identification numbers for the borrower, lead provider, and exchange participant. Additional data fields can optionally be provided to indicate further details about the relevant parties, such as whether the participation opportunity was referred by an alternative financial service provider or other entity. The example in FIG. 4 indicates that the participation opportunity was not referred, and the data field (AD) is labeled as “false.”

Loan details specified under the heading Contract Terms include: (0.1) the date of the loan; (0.2) the amount of the loan; (0.3) the term of the loan in months; (0.4) the type of loan; (0.5) the interest rate; and (0.6) whether the borrower was required to review certain compliance documents before the loan was disbursed. Performance requirements include: (1.1) a required down payment from the borrower of $300,000; (1.2) a monthly loan payment of $62,672; (1.3) a maximum ninety day delinquency period before the loan is defaulted; and (1.4) a requirement that the exchange participant review or indicate agreement with certain documents and terms before purchasing the participation opportunity.

In the embodiment show in FIG. 4, the performance requirements are monitored and the electronic contract is enforced by a software application that verifies the performance requirements and imposes conditions if the requirements are not met. The software application automates the monitoring and enforcement processes, and the application can be configured to monitor the performance requirements continuously or at periodic intervals, such as once a month. The application transmits the appropriate notices to the parties and executes the required payments, among other tasks.

To illustrate, the commands at lines (2.1)-(2.3) in FIG. 4 check the performance conditions at lines (1.1)-(1.3), and the results are indicated in the comments following the backslash characters. Based on these checks, the system determines that: (1) the borrower paid only $250,000 of the required $300,000 down payment; (2) the borrower paid in full the entire monthly payment of $62,672; and (3) the borrower is not more than ninety days delinquent on monthly payments. The function at line (2.4) verifies whether the exchange participant reviewed and electronically signed the required documents, as illustrated in FIG. 14, and the function at line (2.5) verifies whether regulations relating to borrower privacy have been met (i.e., requirements of the Gramm-Leach-Bliley Act).

Once compliance with the performance conditions has been verified, the system enforces the electronic contract by executing software functions that make the necessary payments, send the appropriate notices, and impose conditions for nonperformance. Continuing with the example shown in FIG. 4, because the borrower did not pay the entire amount of the required down payment, the system: (1) executes the function “rateIncrease, 1%” to increase the interest rate of the loan by 1%; and (2) executes the function “accountHold” to place a hold on funds in the borrower's deposit account.

The system also sends notices to the borrower, lead provider, and exchange participant by executing the “sendNotification” software function. The notice can contain information concerning the borrower's noncompliance, the resulting penalties, and the expected payments, as well as any other relevant information. The recipients of the notice are indicated using the unique identification number for the respective parties. The system executes the appropriate payments using the “payment” function. Payments can include withdrawing the monthly mortgage payment from the borrower's deposit account as well as paying the exchange participants the expected share of the monthly loan payment.

The exemplary embodiment illustrated in FIG. 4 is not intended to be limiting, and those of ordinary skill in the art will appreciate that many other terms and parameters of contract creation, administration, and enforcement are possible. As an example, the system can impose certain financial penalties, such as a late fee, on the lead provider if payments are not timely made to exchange participants, or the system can withhold payments to an exchange participant if the participant has not electronically signed required documents.

In one embodiment, the lead provider continues to act as the servicer through the life of a loan underlying a participation opportunity. As the servicer, the lead provider continues to accept monthly payments from the borrower and monitors the borrower's compliance with the terms of the loan. The lead provider can also maintain updated credit information on the borrower and periodically perform capacity, credit, collateral, or other analyses to assess the risk of the loan. The lead provider can, therefore, monitor changes to the borrower's status as well as changes to the value and lien status of the collateral property securing the loan. This in turn allows the system to continuously or periodically evaluate whether a participation opportunity is compatible with an exchange participant's profile data.

The system continuously captures transaction data and stores the data to a transaction history database 106. Historical transaction data can include a wide variety of information relating to the creation, purchase, and enforcement of participation opportunities, as well as information concerning the underlying loans. Historical transaction data can be utilized to update the models used for the matching analysis, as discussed above, as well as to establish a positive or negative transaction history for lead providers. In this manner, lead providers with a positive transaction history relating to the performance of loans underlying a participation opportunity and timely payment of amounts owed to exchange participants can build trust and confidence among exchange participants.

Although the foregoing description provides embodiments of the invention by way of example, it is envisioned that other embodiments may perform similar functions and/or achieve similar results. Any and all such equivalent embodiments and examples are within the scope of the present invention.

What is claimed is:

1. A computer-implemented method of establishing a contract on a network-based exchange comprising the steps of:
(a) providing a computing device associated with an exchange network;
(b) providing a computing device associated with an exchange participant;
(c) providing a member database containing exchange participant profile data;
(d) providing a participation database containing participation opportunity data;
(e) providing participation opportunity data to the exchange participant computing device;
(f) receiving by the exchange network computing device, a participation opportunity purchase request transmitted by the exchange participant computing device; and
(g) generating by the exchange network computing device, an electronic contract in response to the participation opportunity purchase request.

2. The method of claim 1 further comprising the steps of:
(a) performing a matching analysis prior to receiving the participation opportunity purchase request, wherein the matching analysis evaluates two or more participation opportunities and ranks the participation opportunities according compatibility with the exchange participant's profile data; and
(b) providing results of the matching analysis to the exchange participant computing device.

3. The method of claim 1 further comprising the steps of:
(a) performing a matching analysis prior to receiving the participation opportunity purchase request, wherein the matching analysis evaluates one or more participation opportunities for compatibility with the exchange participant's profile data; and
(b) providing results of the matching analysis to the exchange participant computing device.

4. The method of claim 1 further comprising the step of determining by the exchange network computing device, compliance or noncompliance with one or more terms of the electronic contract.

5. The method of claim 4 further comprising the step of imposing a condition for noncompliance with a term of the electronic contract.

6. The method of claim 5, wherein a term of the contract comprises a periodic payment obligation and a condition for noncompliance comprises a financial penalty.

7. The method of claim 1 further comprising the step of receiving by the exchange network computing device, an acknowledgement message transmitted by the exchange participant computing device that acknowledges receipt of participation opportunity data.

8. The method of claim 1, wherein the participation opportunity comprises a financial interest in a loan.

9. The method of claim 8, wherein:
(a) a first term of the electronic contract comprises an obligation for a borrower to make a monthly payment; and
(b) a second term of the electronic contract comprises requiring the exchange participant to acknowledge receipt of participation opportunity data.

10. The method of claim 9 further comprising the steps of:
(a) determining by the exchange network computing device, compliance or noncompliance with the first term and the second term; and
(b) initiating by the exchange network computing device, at least one payment from a lead provider to the exchange participant.

11. The method of claim 10 further comprising the step of imposing by the exchange network computing device, a financial penalty for noncompliance with the first term.

12. A system for establishing a contract on a network-based exchange comprising:
a first processor associated with an exchange network;
a second processor associated with an exchange participant;
a member database containing exchange participant profile data;
a participation database containing participation opportunity data; and
a data storage device including a computer-readable medium having computer readable code for instructing the processors, and when executed by the processors, the processors perform operations comprising:
(a) transmitting by the first processor, participation opportunity data to the second processor;
(b) receiving by the first processor, a participation opportunity purchase request transmitted by the second processor; and
(c) generating by the first processor, an electronic contract in response to the participation opportunity purchase request.

13. The system of claim 12, wherein the first or second processor is further configured to perform the operations of:
(a) performing a matching analysis prior to the operation of receiving the participation opportunity purchase request, wherein the matching analysis evaluates one or more participation opportunities for compatibility with the exchange participant's profile data; and
(b) providing results of the matching analysis to the second processor.

14. The system of claim 12, wherein the first processor is further configured to perform the operation of determining compliance or noncompliance with one or more terms of the electronic contract.

15. The system of claim 14, wherein the first processor is further configured to perform the operation of imposing a condition for noncompliance with the terms of the electronic contract.

16. The system of claim 15, wherein a term of the contract comprises a periodic payment obligation and a condition for noncompliance comprises a financial penalty.

17. The system of claim 12, wherein the first processor is further configured to perform the operation of receiving from the second processor, an acknowledgement message that acknowledges receipt of participation opportunity data.

18. The system of claim 12, wherein the participation opportunity comprises a financial interest in a loan.

19. The system of claim 12 wherein:
(a) a first term of the electronic contract comprises an obligation for a borrower to make a monthly payment; and
(b) a second term of the electronic contract comprises requiring the exchange participant to acknowledge receipt of participation opportunity data.

20. The system of claim 19, wherein the first processor is further configured to perform the operations of:
(a) determining compliance or noncompliance with the first term and the second term;
(b) imposing a financial penalty for noncompliance with the first term; and
(c) initiating at least one payment from a lead provider to the exchange participant.
